(19) United States
(12) Patent Application Publication
(10) Pub. No.: US 2002/0033780 A1
(43) Pub. Date: Mar. 21, 2002

(54) AUTO SIZING AND POSITIONING VIDEO DATA USING GENERALIZED TIMING FORMULA

(76) Inventors: MASANOBU KIMOTO, SAN DIEGO, CA (US); LIBIAO JIANG, SAN DIEGO, CA (US); SHIN FUJIMORI, SAN DIEGO, CA (US); TARO TADANO, SAN DIEGO, CA (US)

Correspondence Address: BLAKELY SOKOLOFF TAYLOR & ZAFMAN, 12400 WILSHIRE BLVD, SEVENTH FLOOR, LOS ANGELES, CA, 90025

(21) Appl. No.: 09/164,093

(22) Filed: Sep. 30, 1998

(51) Int. Cl. G09G 1/06

(52) U.S. Cl. 345/10

(57) ABSTRACT

The present invention is a method and apparatus for generating auto sizing and position data on a video monitor in response to a plurality of video signals. Basic parameters are determined based on the video signals; and derived parameters are calculated using a standardized formula from the basic parameters. The basic and derived parameters provide the auto sizing and positioning data.

### BACKGROUND

1. Field of the Invention

This invention relates to video monitors. In particular, the invention relates to auto sizing and positioning.

2. Description of Related Art

Automatic sizing and positioning of graphic and image to be displayed on the video screen is a desirable feature in many modern video monitors. With auto sizing and positioning, a video monitor can adjust its screen size and place the graphic data at appropriate locations.

FIG. 1 is a diagram illustrating a prior art video system 100 that provides automatic sizing and positioning. The prior art video system 100 includes a graphics system 110, a timing measurement circuit 115, a controller 120, a deflection control circuit 130, and a cathode ray tube (CRT) 140.

The graphic system 110 is any circuit or system that generates video information to be displayed. The video information includes a video signal, a horizontal synchronization (HSYNC), and a vertical synchronization (VSYNC). The timing measurement circuit 115 receives the video signal, the HSYNC, and the VSYNC, and measures other video timing parameters based on these signals. The controller 120 receives the video information as measured by the timing measurement circuit 115 and generates control signals to the deflection control circuit 130. The controller 120 may be any microprocessor or microcontroller that can perform logic and arithmetic calculations. The control signals generated by the controller 120 provide automatic sizing and positioning of the picture. The deflection control circuit 130 controls the horizontal and vertical deflection circuits in the CRT 140. The CRT 140 generates electron beam current to produce photons on the display screen according to the video signal.

To provide automatic sizing and positioning, the graphic system 110 typically provides guiding information as landmark points on the screen. Examples of the guiding information include white pixels at the four corners of the display screen. Using these landmark points, the controller 120 can calculate the proper timing parameters to control the deflection control circuit 130.

The disadvantages of the prior art technique for auto sizing and positioning include the accurate generation of guiding information and the use of the timing measurement circuit 115. The generation of the guiding information puts a design constraint on the graphic system 110 and creates a burden on the graphic system 110. In addition, the timing measurement circuit 115 incurs hardware and complexity to the video monitor system.

Therefore there is a need in the technology to provide a simple and efficient method to achieve automatic sizing and positioning with simple hardware and less burden to the graphic system in the video control circuit.

### SUMMARY

The present invention is a method and apparatus for generating automatic sizing and positioning data on a video monitor in response to a plurality of video signals. Basic parameters are determined based on the video signals; and derived parameters are calculated using a standardized formula from the basic parameters. The basic and derived parameters provide the auto sizing and positioning data.

### BRIEF DESCRIPTION OF THE DRAWINGS

The features and advantages of the present invention will become apparent from the following detailed description of the present invention in which:

FIG. 1 is a diagram illustrating a prior art video system.

FIG. 2 is a diagram illustrating a video system for automatic sizing and positioning according to one embodiment of the invention

FIG. 3A is a diagram illustrating horizontal video parameters for auto sizing and positioning according to one embodiment of the invention.

FIG. 3B is a diagram illustrating vertical video parameters for auto sizing and positioning according to one embodiment of the invention.

FIG. 4 is a flowchart illustrating a process of auto sizing and positioning according to one embodiment of the invention.

### DESCRIPTION

The present invention is a method and apparatus for providing auto sizing and positioning video data using the generalized timing formula (GTF). The technique calculates the derived video parameters from the basic video parameters. The technique therefore simplifies hardware by not requiring a measurement circuit to measure the video parameters.

In the following description, for purposes of explanation, numerous details are set forth in order to provide a thorough understanding of the present invention. However, it will be apparent to one skilled in the art that these specific details are not required in order to practice the present invention. In other instances, well known electrical structures and circuits are shown in block diagram form in order not to obscure the present invention.

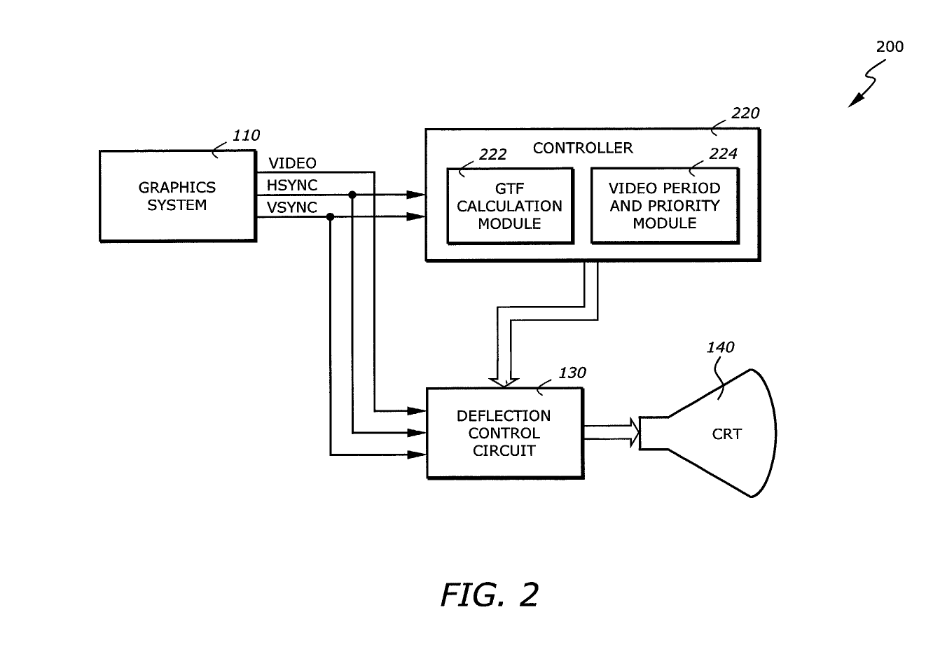

FIG. 2 is a diagram illustrating a video system 200 for automatic sizing and positioning according to one embodiment of the invention. The video system 200 includes the graphic system 110, a controller 220, the deflection control circuit 130, and the CRT 140.

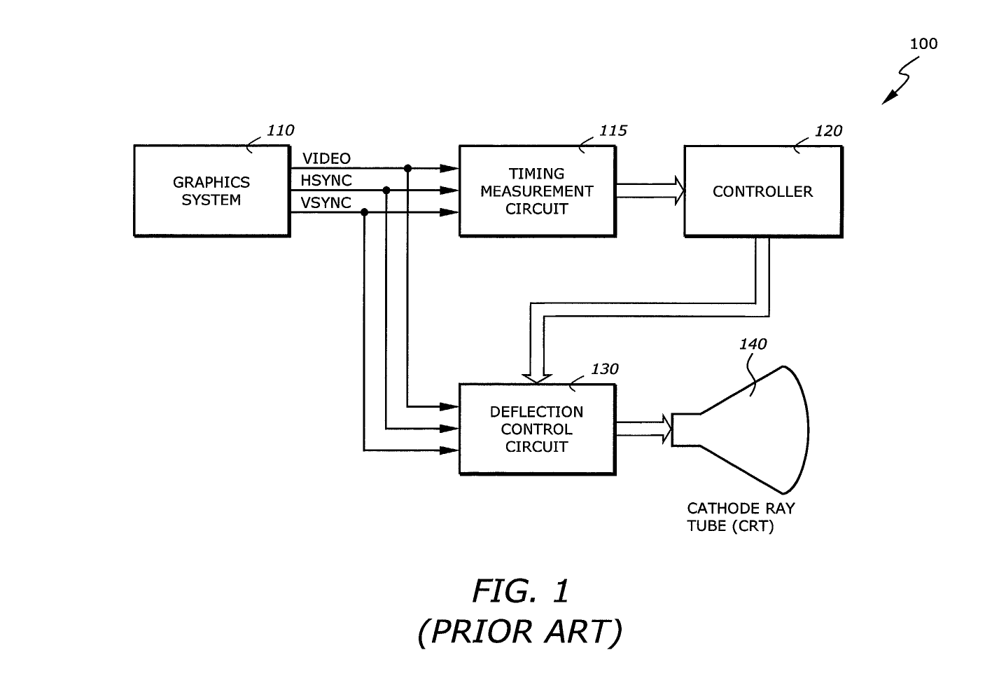

The graphic system 110, the deflection control circuit 130, and the CRT 140 are essentially similar to the corresponding elements in the prior art video system 100 as shown in FIG. 1. Unlike the prior art system 100, the video system 200 does not need the timing measurement circuit 115.

The controller 220 receives the HSYNC and VSYNC signals from the graphic system 110 and generates deflection control signals to the deflection control circuit 130. The controller 220 may be any microprocessor or microcontroller or a hardware logic circuit. The controller 220 includes a GTF calculation module 222 and a video period and polarity module 224. The GTF calculation module 222 may be a logic circuit or a subroutine executed by the processor of the controller 220. The GTF calculation module 222 computes the video timing parameters as provided by the GTF. The video period and display module 224 determines the horizontal period, the vertical period, the horizontal polarity, and the vertical polarity, to be used by the GTF to calculate other timing parameters. The video period and polarity module 224 may be a logic circuit or a program, subroutine to be executed by the controller 220.

The Video Electronics Standards Association (VESA) has defined the Generalized Timing Formula (GTF) to compute video timing parameters. Using the GTF, many graphic systems and video monitors can share information to standardize display modes. In particular, video monitors can achieve automatic picture sizing and positioning to display the generated graphic data or image from the graphics system.

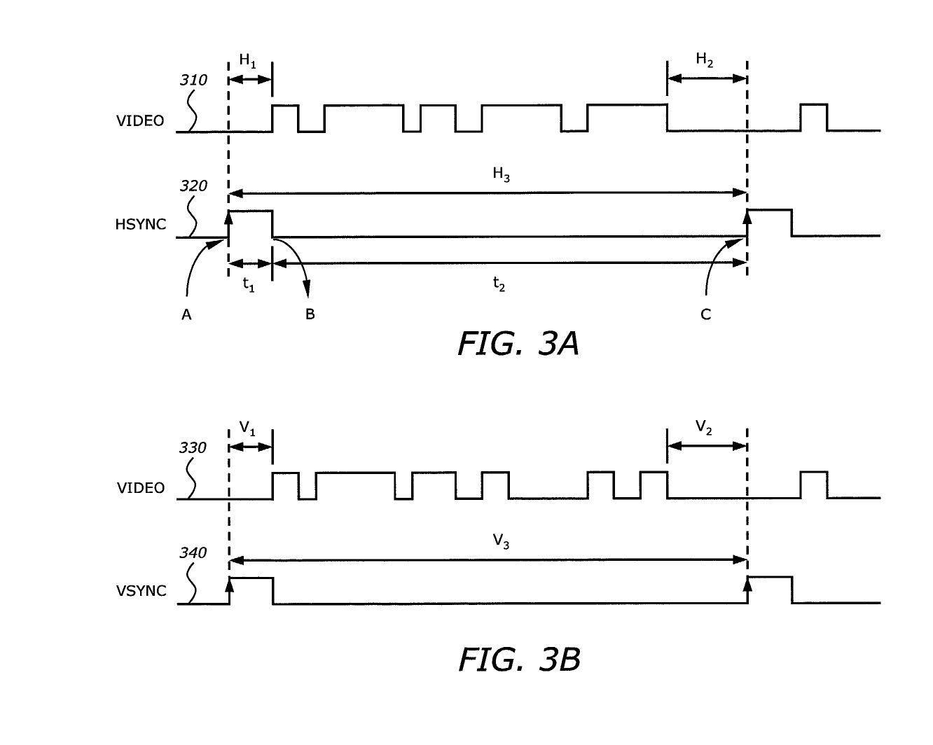

FIG. 3A is a diagram illustrating horizontal video parameters for auto sizing and positioning according to one embodiment of the invention. FIG. 3A includes a video signal 310 and an HSYNC signal 320.

The video signal 310 carries the video information to be displayed on the video screen. The video signal 310 shows the display region for a horizontal line. The HSYNC signal 320 is the horizontal synchronization signal which provides the sync pulse at the beginning of a horizontal line. The three horizontal timing parameters needed for auto sizing and positioning calculations are the H1, H2, and H3 intervals. The H1 interval is the interval between the beginning of the HSYNC pulse and the first valid data in the video signal for the corresponding horizontal line. The H2 interval is the interval between the last valid data in the video signal and the end of the horizontal line, represented by the beginning of the HSYNC pulse in the next horizontal line. The H3 interval is the horizontal period from the beginning of an HSYNC pulse to the next HSYNC pulse.

FIG. 3B is a diagram illustrating the vertical video parameters for auto sizing and positioning according to one embodiment of the invention. FIG. 3B includes a video signal 330 and a VSYNC signal 340.

The video signal 330 carries the video signal at the end of a picture frame corresponding to a vertical retrace. The video signal 310 shows the signal region for a vertical retrace. The VSYNC signal 340 is the vertical synchronization signal which provides the sync pulse at the beginning of a picture frame. The three vertical timing parameters needed for auto sizing and positioning calculations are the V1, V2, and V3 intervals. The V1 interval is the interval between the beginning of the VSYNC pulse and the first valid data in the video signal for the corresponding frame. The V2 interval is the interval between the last valid data in the video signal and the end of the picture frame, represented by the beginning of the VSYNC pulse in the next frame. The V3 interval is the vertical period, expressed in terms of the number of horizontal scan lines, from the beginning of a VSYNC pulse to the next VSYNC pulse.

The GTF signals can be detected based on their polarity as designated by the GTF as follows:

Sync Format Polarity

The polarity of the signal can be detected by using an interrupt scheme and a timer. Alternatively, polling method can also be used to determine if there is a transition in the HSYNC and VSYNC signals. In this scheme, the controller 120 determines the duty cycle of the interval and determines the polarity based on the calculated duty cycle.

Referring to FIG. 3A, when there is a first transition at time A, the controller 120 resets a timer to start counting. When the next transition in the opposite direction occurs at time B, the timer value is read and the time interval t1 is recorded. The timer is then reset again for the next interval in the opposite level. Again, when the next transition in the opposite direction occurs at time C, the timer value is read and the time interval t2 is recorded. The duty cycle is then computed as the ration between t1 and the sum of t1 and t2:

Duty cycle=t1/(t1+t2)

where t1 is the time interval at the HIGH logic level and t2 is the time interval of the LOW logic level.

If the duty cycle is less than a predetermined threshold, say 20%, then it is determined that the polarity is positive; otherwise, the polarity is negative. Similar technique can be used to determine the polarity of the VSYNC signal. The values of the duty cycle threshold for the VSYNC may be slightly different from that of the HSYNC. The timer can be used to measure the timing interval H3. The timing interval V3 can also be determined by counting the number of horizontal lines within the frame.

The video periods H3 and V3 and the vertical polarity (VPOL) and horizontal polarity (HPOL) are determined by the video period and polarity module 224 in FIG. 2.

The GTF provide the following formula to calculate the derived parameters H1, H2, V1, and V2:

Htemp=(30−300×f_{H})/2 where f_{H} is in KHz.

H1=H3×{8%+Htemp%}

H2=H3×{Htemp%−8%}

H3=period of the horizontal synchronization signal.

V1=550 microsec/H3

V2=1

V3=number of scan lines per frame.

These values are calculated by the GTF calculation module 222 shown in FIG. 2.

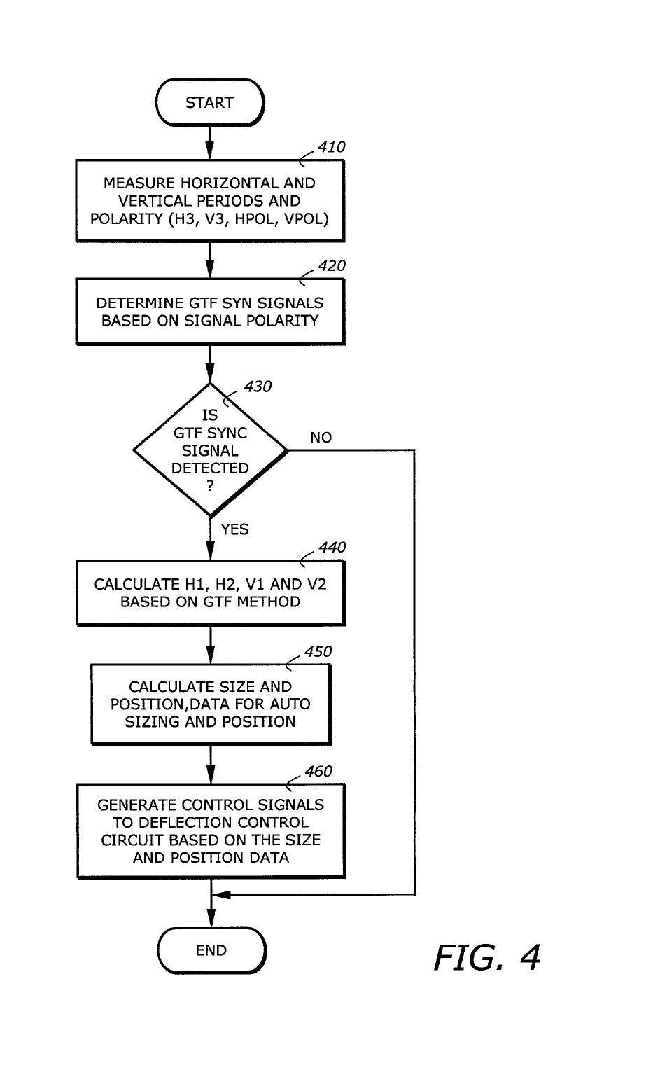

FIG. 4 is a flowchart illustrating a process 400 of auto sizing and positioning according to one embodiment of the invention.

Upon START, the process 400 measures the horizontal period H3, the vertical period V3, the horizontal polarity HPOL, and the vertical polarity VPOL (Block 410). Then the process 400 determines the GTF sync signals based on the signal polarity (Block 420).

The process 400 then determines if the GTF signals have been detected (Block 430). If not, the process 400 is terminated. If the GTF signals have been detected and determined, the process 400 calculates the H1, H2, V1, and V2 timing intervals based on the GTF method (Block 440). The process 400 then calculates the size and position data for auto sizing and positioning using the calculated values of H1, H2, V1, and V2, and the measured values H3 and V3 (Block 450).

Next, the process 400 generates the control signals to the deflection control circuit based of the size and position data. The process 400 is then terminated.

The present invention provides a technique to provide auto sizing and positioning of video data in a video monitor. The technique calculates the video timing parameters using the GTF method without using a measurement circuit. In addition, the technique does not require the generation of landmark graphic data from the graphic system.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method for generating auto sizing and position data on a video monitor in response to a plurality of video signals, the method comprising:
(a) determining basic parameters based on the video signals; and
(b) calculating derived parameters using a standardized formula from the basic parameters, the basic and derived parameters providing auto sizing and positioning data.

2. The method of claim 1 wherein the video signals include an active video signal, a horizontal synchronization (HSYNC) signal, and a vertical synchronization (VSYNC) signal.

3. The method of claim 1 wherein the basic parameters include a horizontal period, a vertical period, a horizontal polarity, and a vertical polarity.

4. The method of claim 1 wherein the derived parameters include a beginning horizontal interval, an ending horizontal interval, a beginning vertical interval, and an ending vertical interval.

5. The method of claim 1 wherein the standardized formula is a generalized timing formula (GTF).

6. The method of claim 1 further comprising:
(c) generating control signals to a deflection control circuit based on the auto sizing and positioning data.

7. The method of claim 3 wherein the determining the basic parameters comprises:
(a1) detecting a signal transition of the video signals;
(a2) calculating a duty cycle of the video signals; and
(a3) comparing the duty cycle with a predetermined threshold.

8. An apparatus for generating auto sizing and position data on a video monitor in response to a plurality of video signals, the apparatus comprising:
a controller to receive the video signals, the controller determining basic parameters and calculating derived parameters using a standardized formula from the basic parameters, the basic and derived parameters providing auto sizing and positioning data.

9. The apparatus of claim 8 wherein the video signals include an active video signal, a horizontal synchronization (HSYNC) signal, and a vertical synchronization (VSYNC) signal.

10. The apparatus of claim 8 wherein the basic parameters include a horizontal period, a vertical period, a horizontal polarity, and a vertical polarity.

11. The apparatus of claim 8 wherein the derived parameters include a beginning horizontal interval, an ending horizontal interval, a beginning vertical interval, and an ending vertical interval.

12. The apparatus of claim 8 wherein the standardized formula is a generalized timing formula (GTF).

13. The apparatus of claim 8 further comprising:
a deflection control circuit coupled to the controller to receive the control signals from the controller, the control signals being based on the auto sizing and positioning data.

14. The apparatus of claim 10 wherein the controller executes a program to:
detect a signal transition of the video signals;
calculate a duty cycle of the video signals; and
compare the duty cycle with a predetermined threshold.

15. A system comprising:
a graphic subsystem to generate a plurality of video signals;
a controller coupled to the graphic subsystem to generate auto sizing and position data on a video monitor in response to the plurality of video signals, the controller determining basic parameters and calculating derived parameters using a standardized formula from the basic parameters, the basic and derived parameters providing auto sizing and positioning data.

16. The system of claim 15 wherein the video signals include an active video signal, a horizontal synchronization (HSYNC) signal, and a vertical synchronization (VSYNC) signal.

17. The system of claim 15 wherein the basic parameters include a horizontal period, a vertical period, a horizontal polarity, and a vertical polarity.

18. The system of claim 15 wherein the derived parameters include a beginning horizontal interval, an ending horizontal interval, a beginning vertical interval, and an ending vertical interval.

19. The system of claim 15 wherein the standardized formula is a generalized timing formula (GTF).

20. The system of claim 15 further comprising:
a deflection control circuit coupled to the controller to receive the control signals from the controller, the control signals being based on the auto sizing and positioning data.
